(19) United States
(12) Patent Application Publication
(10) Pub. No.: US 2025/0025366 A1
(43) Pub. Date: Jan. 23, 2025

(54) MULTIFUNCTIONAL FASCIA BALL

(71) Applicant: XIAO YU, Ningbo (CN)

(72) Inventor: FENG YE, Cixi (CN)

(21) Appl. No.: 18/373,576

(22) Filed: Sep. 27, 2023

(30) Foreign Application Priority Data
Jul. 17, 2023 (CN) 202321872131.X

(51) Int. Cl. A61H 15/00; A61H 39/04

(52) U.S. Cl. CPC A61H 15/0092; A61H 39/04; A61H 2015/0042

(57) ABSTRACT

This patent application discloses a multifunctional fascia ball, comprising a fascia ball body with a massage core located inside, the fascia ball body is divided into an upper fascia ball cover and a lower fascia ball cover, and there are scraping and massaging blocks located at the bottom of the massage core, and acupressure blocks at the top of the massage core. This device achieves multiple massage purposes using a single fascia ball, such as acupressure massage, meridian scraping, neck and fascia ball pressing, and so on. Additionally, this device is compact and easy to carry, effectively addressing the need for muscle massages in various body parts, avoiding consumers from having to repeatedly purchase different types of massage devices. Moreover, this device is cost-effective, suitable for massaging muscles throughout the body, and is convenient to carry and use.

### CROSS-REFERENCE TO RELATED APPLICATIONS

This is a U.S. patent application which claims the priority and benefit of Chinese Patent Application Number 20232187213.X, filed on Jul. 17, 2023, the disclosure of which is incorporated herein by reference in its entirety.

### TECHNICAL FIELD

This patent application relates to a multifunctional fascia ball.

### BACKGROUND

Products in the existing technology are typically spherical massage devices that achieve muscle relaxation through the sliding motion of the sphere. However, these spherical fascia balls have limited functionality, as they can only massage a few specific muscle points, lack comprehensive massage capabilities, are not user-friendly, and often provide insufficient muscle stimulation. Therefore, there is a need for a multifunctional fascia ball that addresses these issues.

### SUMMARY

The technical problem to be solved by this patent application is to provide a multifunctional fascia ball. To solve the above problem, the patent application employs the following technical solution:

A multifunctional fascia ball comprises:

The fascia ball body is divided into an upper fascia ball cover and a lower fascia ball cover.

At the bottom of the massage core, there are scraping massage blocks, and at the top of the massage core, there are acupressure blocks.

Additionally, it is preferred that:

There is a connecting base positioned in the middle of the massage core. The scraping massage blocks and acupressure blocks are respectively positioned at the top and bottom of the connecting base.

There are locking blocks on the inner side of the upper fascia ball cover, and on the surface of the connecting base near the bottom, there are matching locking slots that correspond to the locking blocks.

On the inner side of the lower fascia ball cover, there is a first locking block, and on the surface of the connecting base near the top, there is a first locking slot that matches the first locking block.

The lower fascia ball cover has operation blocks positioned near the top at its front and rear ends.

The lower fascia ball cover serves as a cervical spine massage block.

Advantageous Effects of the patent application:

This device achieves multiple massage purposes using the same fascia ball. It can be used for various purposes such as acupressure massage, meridian scraping, neck pressure, and fascia ball massage. Moreover, this device is compact and portable, effectively catering to muscle massage needs across different body areas. This design eliminates the need for consumers to repetitively purchase various massage devices with different functions.

### BRIEF DESCRIPTION OF DRAWINGS

FIG. 1 is a main view of this patent application;

FIG. 2 is an assembly schematic diagram of the scraping massage block;

FIG. 3 is an assembly schematic diagram of the acupressure block;

FIG. 4 is a schematic diagram of the massage core;

FIG. 5 is a three-dimensional view of this patent application.

### REFERENCE SIGNS

101—Fascia ball body
102—massage core
103—upper fascia ball cover
104—lower fascia ball cover
105—scraping massage blocks
106—acupressure blocks
107—connecting base
108—matching locking slots
109—first locking slot
110—operation blocks

### DETAILED DESCRIPTION

All features disclosed in this specification, or all methods or steps disclosed in the specification or the prior art, can be combined in any combination, except for features and/or steps that are mutually exclusive. Any feature disclosed in this specification (including any claims, abstract, and drawings) may be replaced by alternative features that serve the same or a similar purpose unless specifically stated. In this specification, it should be understood that directional or positional relationships, such as “one end,” “the other end,” “outer,” “upper,” “inner,” “horizontal,” “coaxial,” “central,” “end,” “length,” “outer end,” etc., are based on the orientation or position relationships shown in the drawings for ease of describing this patent application and for simplification. They do not indicate or imply that the device or elements must have specific orientations, construct and operate in specific orientations, and therefore should not be interpreted as limiting the patent application.

In addition, in the description of this patent application, the term “multiple” means at least two, for example, two, three, etc., unless otherwise specifically defined.

In this patent application, unless otherwise specified and limited, terms such as “set,” “socket,” “connect,” “penetrate,” “insert,” and the like should be broadly interpreted. For example, it can be a fixed connection or a detachable connection, or it can be integral; it can be a mechanical connection or an electrical connection; it can be directly connected or indirectly connected through an intermediate medium; it can be a communication inside two elements or an interaction between two elements unless otherwise specified. For those skilled in the art, the specific meanings of these terms in this patent application can be understood based on the specific context.

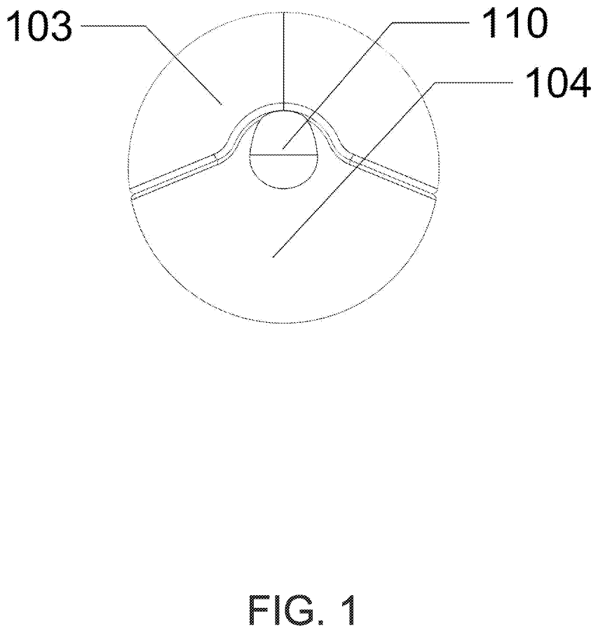

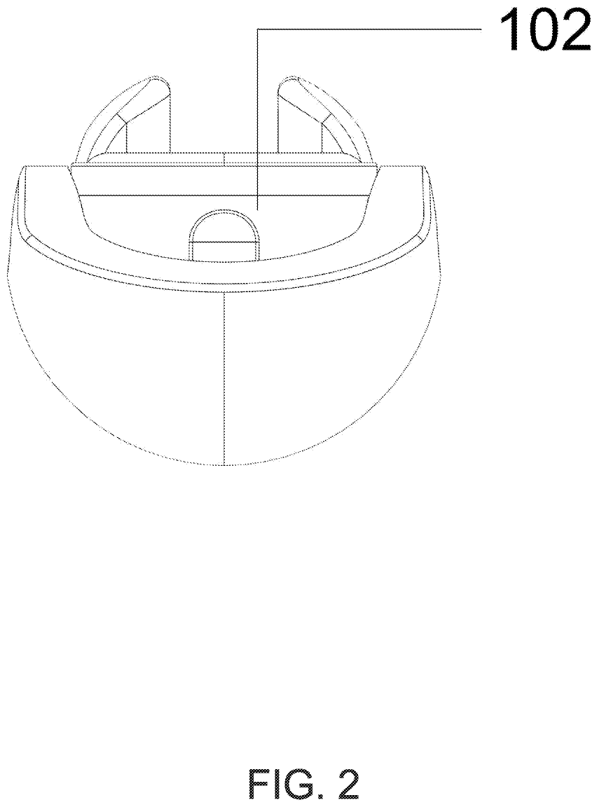

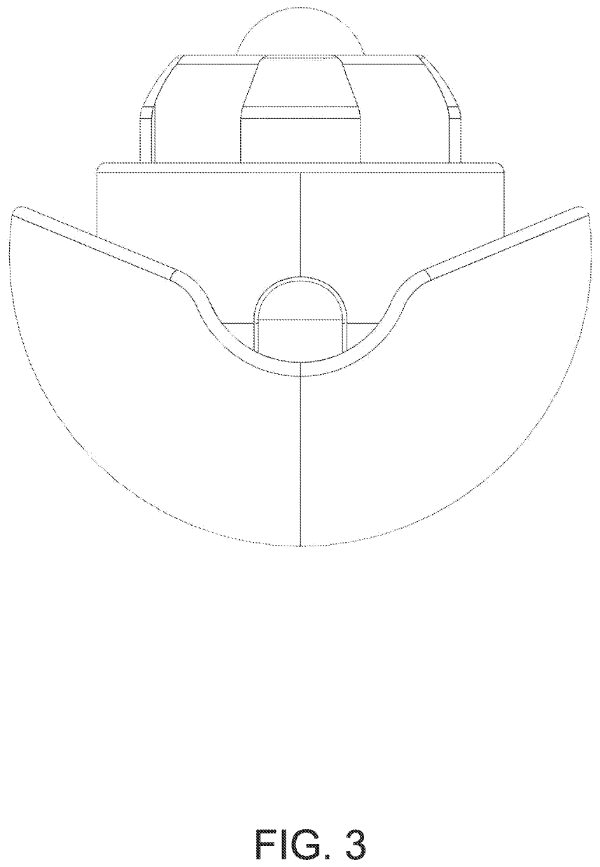

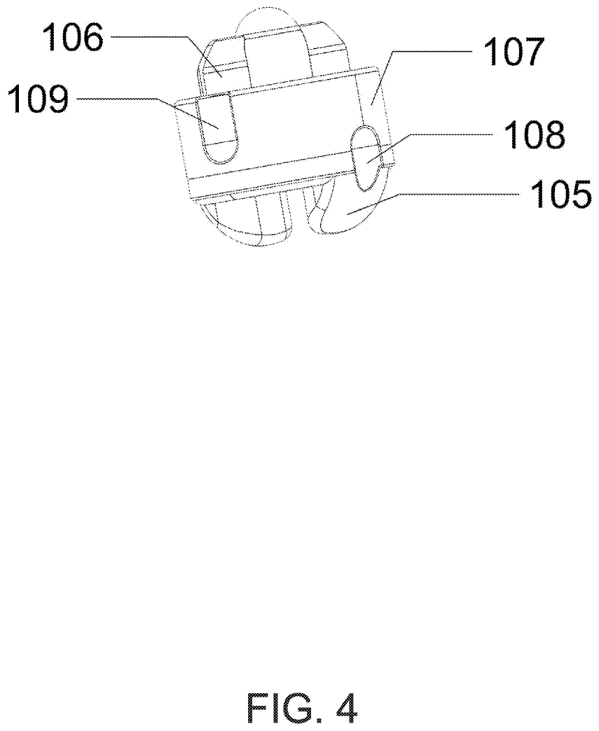

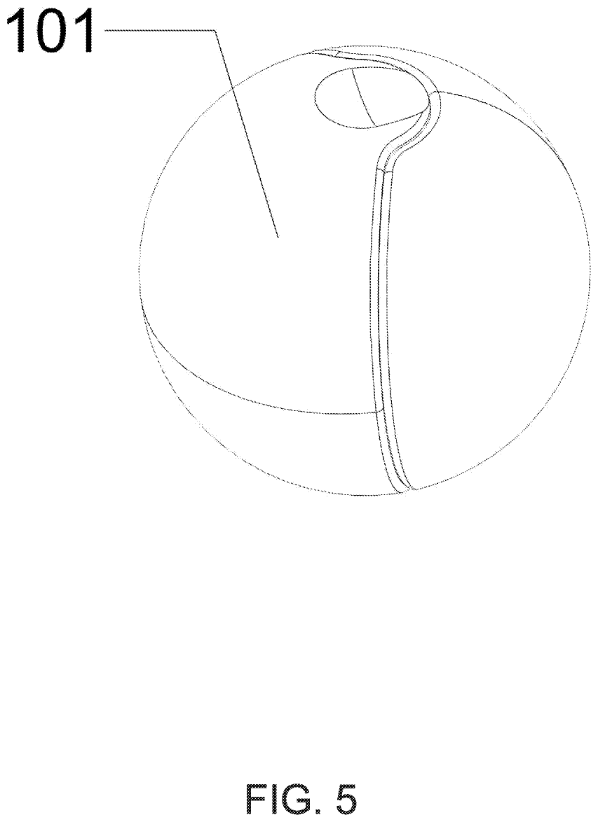

Referring to FIGS. 1, 2, 3, 4, and 5, a multifunctional fascia ball is shown, comprising:

Fascia ball body 101, with a massage core 102 positioned inside.

The fascia ball body 101 is divided into an upper fascia ball cover 103 and a lower fascia ball cover 104.

At the bottom of the massage core 102, there are scraping massage blocks 105, and at the top of the massage core 102, there are acupressure blocks 106.

In a preferred embodiment of this patent application, there is a connecting base 107 positioned in the middle of the massage core 102, and the scraping massage blocks 105 and the acupressure blocks 106 are respectively positioned at the top and bottom of the connecting base 107. There are locking blocks on the inner side of the upper fascia ball cover 103, and on the surface of the connecting base 107 near the bottom, there are matching locking slots 108 that correspond to the locking blocks. On the inner side of the lower fascia ball cover 104, there is a first locking block, and on the surface of the connecting base 107 near the top, there is a first locking slot 109 that matches the first locking block. The lower fascia ball cover 104 has operation blocks 110 positioned near the top at its front and rear ends.

In one preferred embodiment, the lower fascia ball cover 104 serves as a cervical spine massage block. When used separately, the lower fascia ball cover can be used as a cervical spine massager.

This device divides the fascia ball into upper and lower parts, with an independent massage core inserted in between. The massage core has two ends, one for acupressure massage and the other for meridian scraping.

Function 1: When the two halves of the spherical ball are closed together, it can be used as a standard fascia ball.

Function 2: Separating the upper and lower halves of the fascia ball allows the independent lower fascia ball cover to have an effect on pressing the neck.

Function 3: Inserting the lower fascia ball cover into the acupressure block allows it to be used for meridian scraping using the scraping massage block.

Function 4: Inserting the upper fascia ball cover into the scraping massage block allows it to be used for acupressure massage using the acupressure block.

It should be noted that the terms used here are intended for describing specific embodiments and not for limiting this patent application.

The terms “comprising” and/or “including” when used in this specification and the claims refer to the presence of features, steps, operations, devices, components, and/or their combinations unless otherwise specified.

Unless otherwise specifically stated, the relative arrangement, numerical expressions, and values of components and steps described in these embodiments are not intended to limit the scope of this patent application.

In addition, it should be understood that the spatial relative terms such as “above,” “over,” “on,” “on top of,” “above,” etc., used here to describe the spatial position relationship of one device or feature with respect to others are for the convenience of describing the spatial position relationship of the device or feature with respect to others as shown in the drawings. It should be understood that these spatial relative descriptions are intended to encompass orientations other than those specifically depicted in the drawings, as required for use or operation. For example, if a device in the drawings is inverted, the device described as “above” or “on top of” another device or structure will be positioned as “below” or “beneath” the other device or structure. Therefore, the exemplary term “above” can include both “above” and “below” orientations. The device can also be positioned differently (rotated 90 degrees or in other orientations), and appropriate explanations should be made for the spatial relative descriptions used here.

It should be noted that the terms used here are intended for describing specific embodiments and not for limiting this patent application.

The exemplary term “comprising” used in this specification and the claims refers to the presence of features, steps, operations, devices, components, and/or their combinations unless otherwise specified.

It should be understood that the term “comprising” and/or “including” when used in this specification and the claims is intended to encompass the presence of features, steps, operations, devices, components, and/or their combinations.

It should be noted that this description and the claims and the above-mentioned drawings use the terms “first,” “second,” etc., to distinguish similar objects and are not intended to describe a specific order or sequence. It should be understood that these terms can be interchanged as needed for the exemplary embodiments of this application to be implemented, except as otherwise depicted or described here.

The above description is only exemplary of the preferred embodiments of this patent application and is not intended to limit this patent application. Various changes and modifications can be made by those skilled in the art. All such changes and modifications are intended to be included within the scope of this patent application.

What is claimed is:

1. A multifunctional fascia ball, characterized by: comprising a fascia ball body (101), with a massage core (102) positioned inside the fascia ball body (101). The fascia ball body (101) is divided into an upper fascia ball cover (103) and a lower fascia ball cover (104), with scraping massage blocks (105) located at the bottom of the massage core (102) and acupressure blocks (106) located at the top of the massage core (102).

2. The multifunctional fascia ball according to claim 1, characterized in that: there is a connecting base (107) positioned in the middle of the massage core (102). The scraping massage blocks (105) and acupressure blocks (106) are respectively positioned at the top and bottom of the connecting base (107). There are locking blocks on the inner side of the upper fascia ball cover (103), and there are matching locking slots (108) on the surface of the connecting base (107) near the bottom, which correspond to the locking blocks. There is a first locking block on the inner side of the lower fascia ball cover (104), and there is a first locking slot (109) on the surface of the connecting base (107) near the top, which corresponds to the first locking block.

3. The multifunctional fascia ball according to claim 1, characterized in that: there are operation blocks (110) positioned near the top on the front and rear ends of the lower fascia ball cover (104).

4. The multifunctional fascia ball according to claim 1, characterized in that: the lower fascia ball cover (104) serves as a cervical spine massage block.
